(19) United States
(12) Patent Application Publication
(10) Pub. No.: US 2024/0209675 A1
(43) Pub. Date: Jun. 27, 2024

(54) Steel Cage to Hold and Secure Objects

(71) Applicant: Ryan Curtis, Rancho Santa Margarita, CA (US)

(72) Inventor: Ryan Curtis, Rancho Santa Margarita, CA (US)

(21) Appl. No.: 18/392,179

(22) Filed: Dec. 21, 2023

Related U.S. Application Data
(60) Provisional application No. 63/434,867, filed on Dec. 22, 2022.

(51) Int. Cl. E05G 1/026; E05B 65/00; E05G 1/024; E05G 1/04

(52) U.S. Cl. CPC E05G 1/026; E05B 65/0075; E05G 1/024; E05G 1/04; E05G 1/005

(57) ABSTRACT

A cover is closed on five sides and open on a sixth side, allowing a case to be slid into the cavity formed by the five closed sides. A hasp or plate secures the front of the cover, preventing a thief from opening the case to remove its contents and from pulling the case out of the cover. The cover can be solid, made from steel or another hard substance, and can also be mesh. The cover has bolt holes or other means by which the cover can be secured to a large object such as the bed of a pickup truck.

### CROSS REFERENCE TO RELATED APPLICATIONS

This Utility patent application claims priority back to U.S. Provisional No. 63/434,867, filed Dec. 22, 2022, the contents of which are incorporated by reference.

### STATEMENT REGARDING FEDERALLY SPONSORED RESEARCH OR DEVELOPMENT

This invention was not federally sponsored.

### INVENTOR

Ryan Curtis, citizen of USA, resident of Rancho Santa Margarita, CA.

### BACKGROUND OF THE INVENTION

### Field of the Invention

This invention relates to the general field of protective and storage boxes, and more specifically to locking case covers that can be used to effectively and easily secure a case with valuables inside.

### Brief Description of Invention

The present invention is a case cover that has a top portion, a bottom portion, and two sides that are connected to each other to create a cavity into which a case containing valuables such as guns or drones can be inserted, and then secured with a hasp the attaches to the bottom of the case and has a hole that lines up with a loop on the upper case, thereby allowing a person to put a padlock through the loop to secure the case inside the cover. The cage is preferably made from steel or another tough material, and the cage is designed to snugly retain the case within its confines, thereby minimizing damage to the contents from rattling or shaking. The invention has several embodiments allowing for attachment of the cover to a vehicle or other large object, and there are also embodiments allowing for the length, width and height of the cover to be adjusted for different sizes of cases.

### Statement of the Problem

There are cases intended to protect delicate items, such as guns and drones, from the weather. However, these cases often do not have adequate means to protect the cases from being opened, or just stolen. Such a theft would leave the owner poorer for the experience, and in the cases of stolen guns, potentially legally liable—both situations being undesirable for the owner. Thus, there has existed a long-felt need for a cover that both protects the contents of a case against the case being opened and removed, and also protects the entire case from being stolen.

The current invention provides just such a solution by having a simple, metal case cover that has a top and bottom portion that are connected to each other to create a cavity into which a case containing valuables such as guns or drones can be inserted, and then secured with a hasp the attaches to the bottom of the case and has a hole that lines up with a loop on the upper case, thereby allowing a person to put a padlock through the loop to secure the case inside the cover. The invention has several embodiments allowing for attachment of the cover to a vehicle or other large object, and there are also embodiments allowing for the length, width and height of the cover to be adjusted for different sizes of cases.

### Prior Art

There is prior art that attempts to rectify this problem.

For example, U.S. Pat. No. 7,004,365 to Ingram for a transport cage with enclosed case describes a transport cage (“cage”) and enclosed case combination, wherein the cage is adapted to attach to a vehicle rack where the cage functions simultaneously as a transport container and as a supplemental rack. The cage comprises a first and second tubular framework respectively defining an open box (“box”) and a lid. The lid can move between an open and closed position with respect to the box. In the preferred embodiment the cage is designed to accommodate a rifle case. At least one connector enables the cage to be connected to a vehicle rack. The first or second tubular framework enables additional items to be attached to the cage such that the cage acts as a supplemental rack. The cage and case combination is particularly suited to carrying additional items on an ATV rack thereby extending the carrying capacity of an ATV rack. This invention, however, is overly cumbersome and lacks the ability to adjust to different sizes of cases.

U.S. Pat. No. 9,951,551 to Stack Arms LLC for a portable storage safe with flexible internal locking cage describes a method for securing a storage safe formed from a flexible fabric having a generally rectangular closeable outer shell, at least one longitudinal cable conduit channel and at least one latitudinal cable conduit channels and a plurality of wire cables of predefined length substantially disposed within said cable conduit channels wherein said longitudinal and latitudinal cables traverse the interior surfaces of the outer shell and further wherein said wire cable ends extend beyond said cable conduit channels; adjustable cable locks in operative contact with each wire cable end; at least one storage container disposed within said outer shell, wherein the wire cables are positioned within said wire conduit channels are drawn down upon and tightened on said storage container to form a wire cage and said each adjustable cable lock engages the opposite end of said wire cables end to securely lock the wire cables in place and further comprising a plurality of voids on a lower surface thereof and a separate cable segment and adjustable lock for securing said safe to a structure tie down. This product, however, is made from a flexible fabric which presumably could be cut through to steal the contents of the storage safe and requires wire cables to actually secure the contents. This is considerably more complicated than the current invention.

Finally, Chinese Patent No. 107143216 for a Container cage and container locking mechanism describes a container-locking mechanism on a container cage, with a complicated combination of locks and action bars with tapered ends and lock collars. As with the other prior art cited in this application, this patent describes an overly complicated means to secure items in a cover or cage.

### OBJECTS OF THE INVENTION

A first object of the invention is to provide a simple, inexpensive means by which a case owner can prevent the case from being opened or stolen.

A second object of the invention is to provide an adjustable cover that can be enlarged or contracted to fit a variety of sizes of cases.

A third object of the invention is to have means by which the case cover can be permanently or removably attached to a large object such as a pickup truck bed

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

Several preferred forms of the invention will now be described with reference to the accompanying drawings.

The general concept of the invention is to provide a cover that is closed on five sides and open in the front, thereby allowing a case to be inserted into the cavity. There is some means by which the front of the cover can be removably secured to prevent a thief from simply pulling the case out, or opening the case to remove the valuables. The invention also provides some means by which the device can be secured to a larger object, such as the bed of a pickup truck.

FIG. 1 is a perspective view of a first embodiment of the cover.

FIG. 2 is a second perspective view of the first embodiment of the cover.

FIG. 3 is a top view of the first embodiment of the cover.

FIG. 4 is a bottom view of the first embodiment of the cover.

FIG. 5 is a front view of the first embodiment of the cover.

FIG. 6 is a perspective view of a second embodiment of the cover.

FIG. 7 is a bottom view of the second embodiment of the cover.

FIG. 8 is a front view of the second embodiment of the cover.

FIG. 9 is a bottom, perspective view of the second embodiment of the cover.

FIG. 10 is a perspective view of a third embodiment of the cover.

FIG. 11 is a front view of the third embodiment of the cover.

FIG. 12 is a top view of the third embodiment of the cover.

FIG. 13 is a side-perspective view of a fourth embodiment of the invention.

FIG. 14 is a front, perspective view of the invention with an integrated lock.

### DETAILED DESCRIPTION OF THE FIGURES

The present invention is a cover designed to secure a case against both outright theft and opening of the case to remove valuables such as guns or drones.

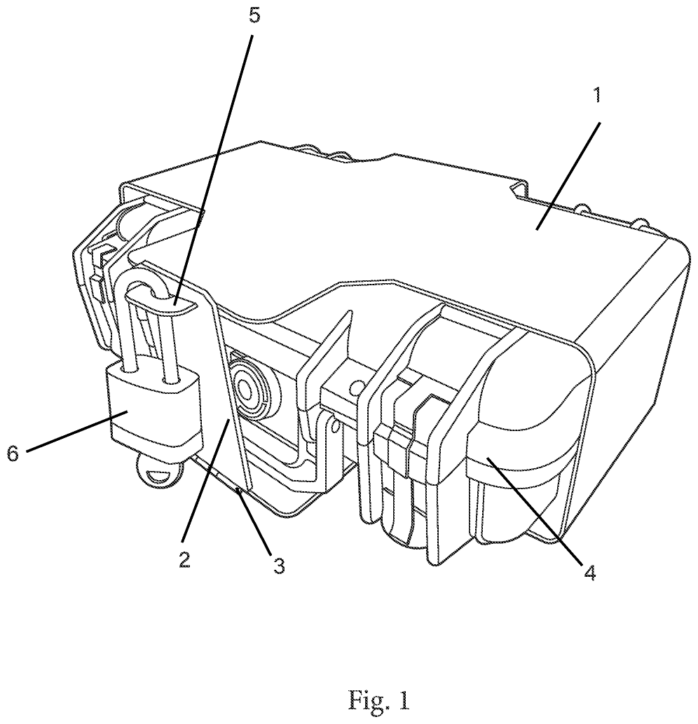

FIG. 1 is a perspective view of a first embodiment of the cover. A cover 1 has a top, a bottom, two sides and a back, with an open front such that a case 4 can be slid into the internal cavity of the cover 1. A hasp 2 is attached to the bottom of the cover by a hinge 3, which allows the hasp 2 to rotably engage a loop 5. The loop 5 has a hold into which a padlock can be placed to secure the case 4 within the cover 1.

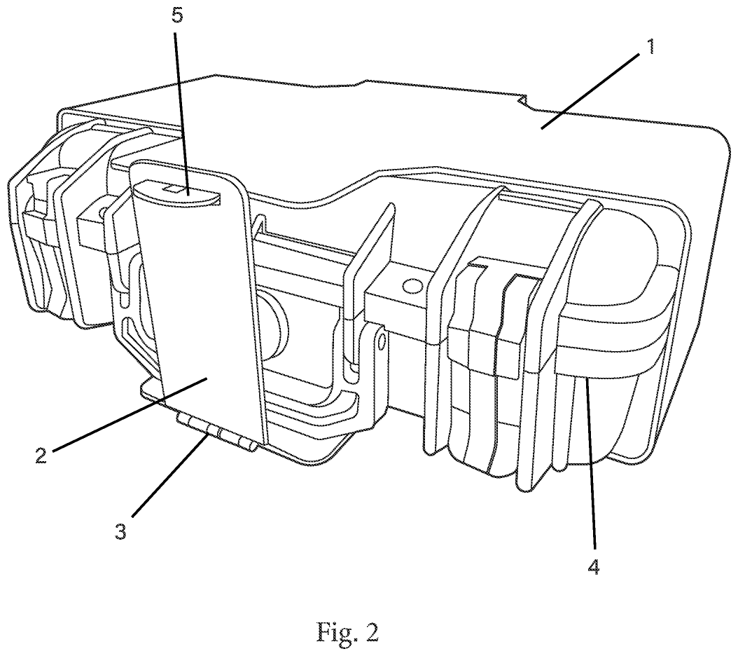

FIG. 2 is a second perspective view of the first embodiment of the cover.

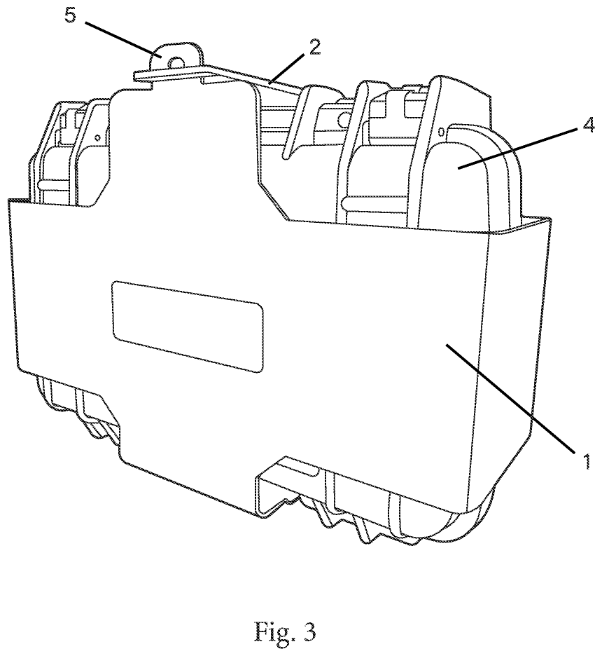

FIG. 3 is a top view of the first embodiment of the cover.

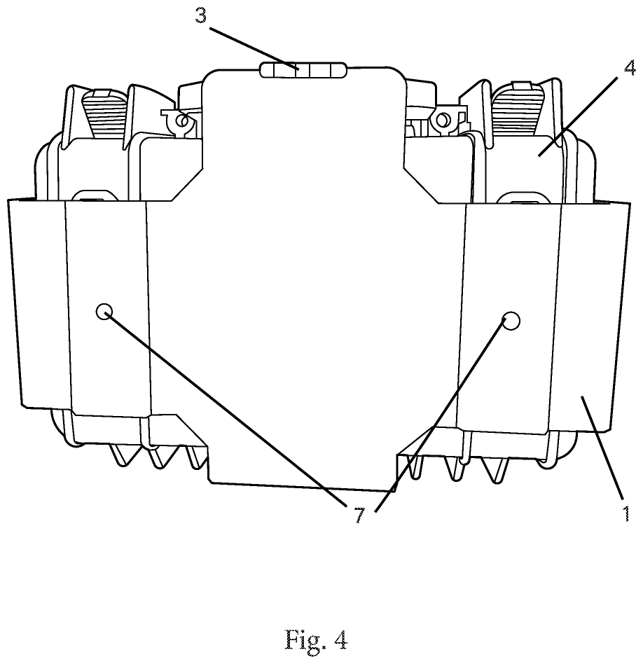

FIG. 4 is a bottom view of the first embodiment of the cover. This bottom view shows the bolt holes 7, through which bolts can be placed to secure the cover 1 to a large object such as the bed of a pickup truck.

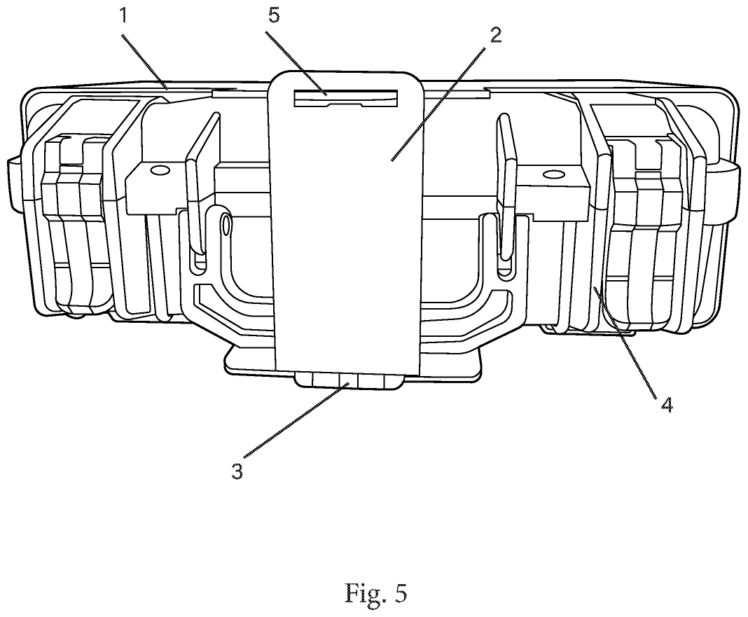

FIG. 5 is a front view of the first embodiment of the cover.

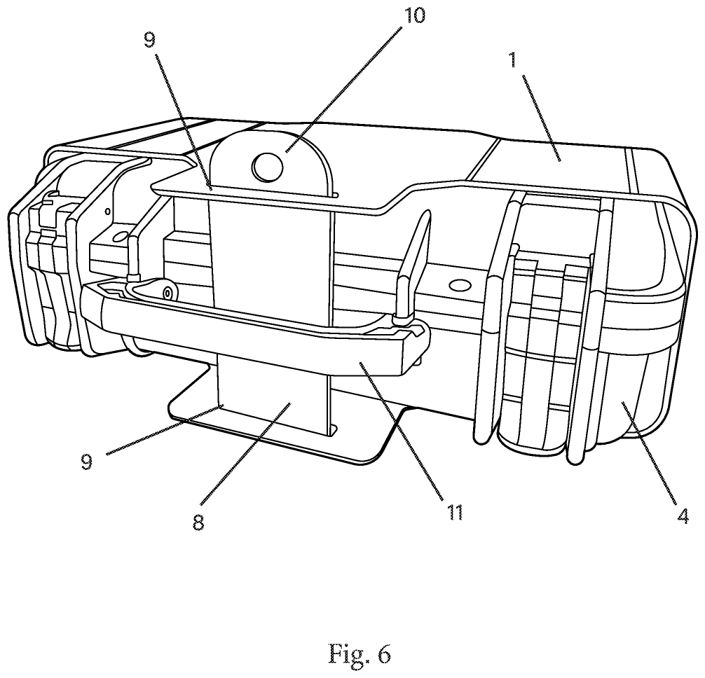

FIG. 6 is a perspective view of a second embodiment of the cover. The cover 1 provides protection on five of the six sides, leaving open the front, which allows the case 4 to be inserted. The cover has two plate slots 9, through which a plate 8 can be inserted. The plate 8 has a plate hole 10, into which a padlock can be attached to lock the case 4 inside the cover 1. This allows a user to carry the cover 1 and case 4 by the case handle 11.

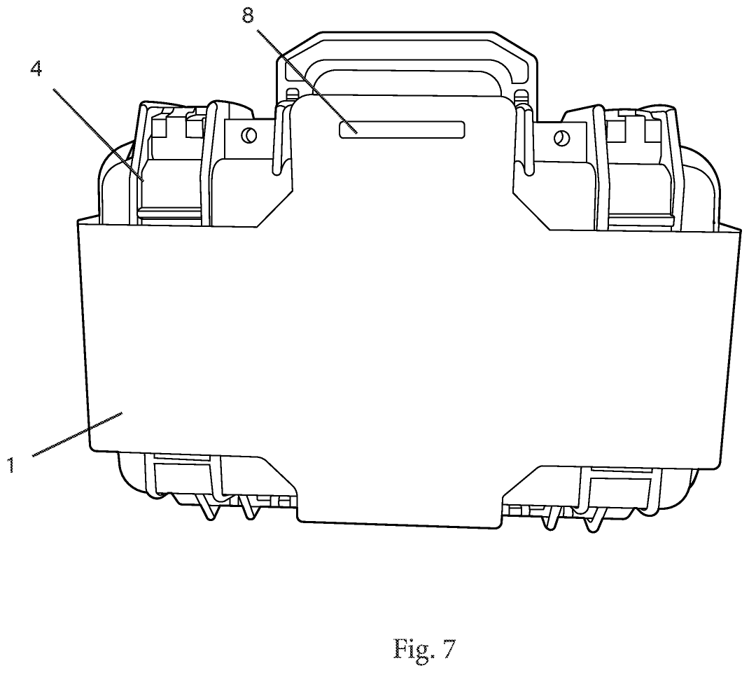

FIG. 7 is a bottom view of the second embodiment of the cover.

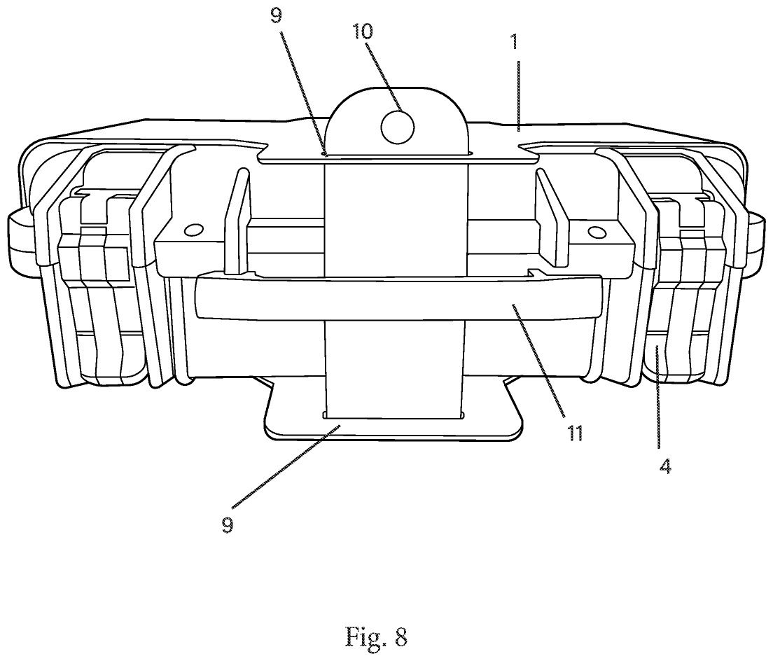

FIG. 8 is a front view of the second embodiment of the cover.

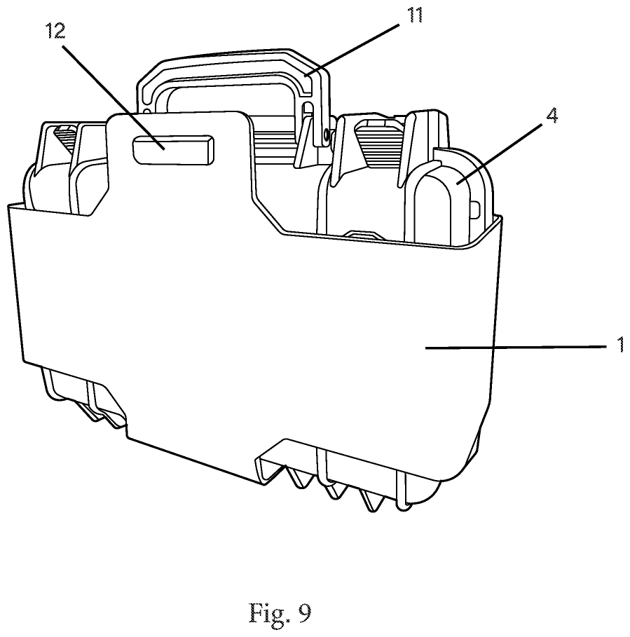

FIG. 9 is a bottom, perspective view of the second embodiment of the cover. This figure shows how the lower section of the plate (8 in other figures) is secured by a stopper 12, where the stopper 12 is larger in width than the plate slots.

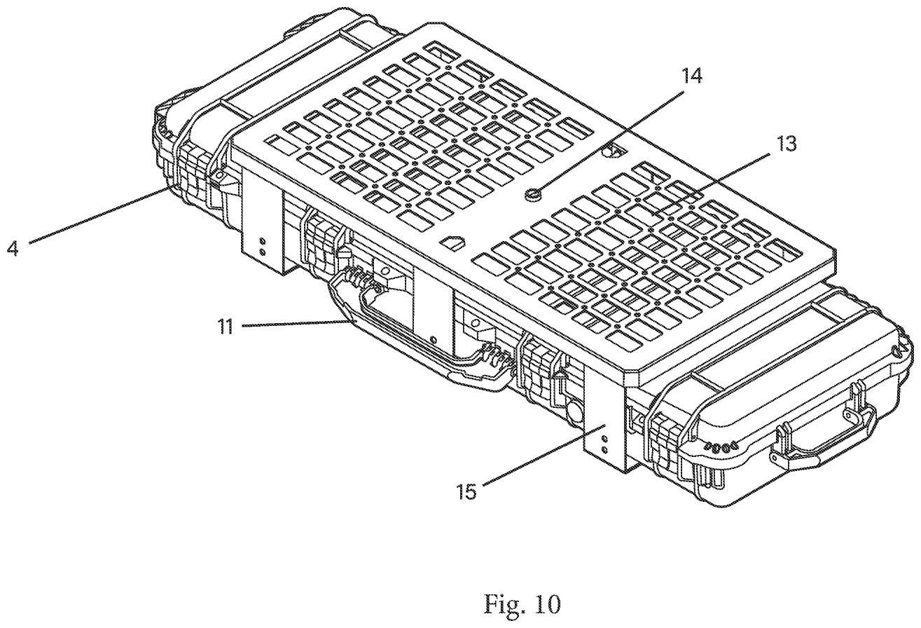

FIG. 10 is a perspective view of a third embodiment of the cover. This cover has mesh openings 13 to make the cover lighter. Three uprights 15 slide across the front of the cover to secure the case 4. The case handle 11 extends out beyond one of the uprights to allow for the cover and case to be carried. A securing screw 14 provides addition security by attaching the cover to the case directly.

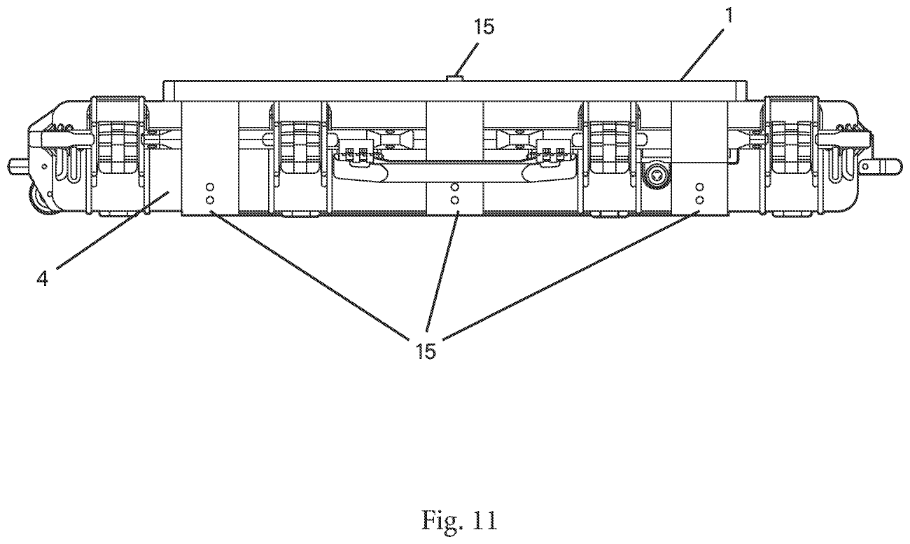

FIG. 11 is a front view of the third embodiment of the cover.

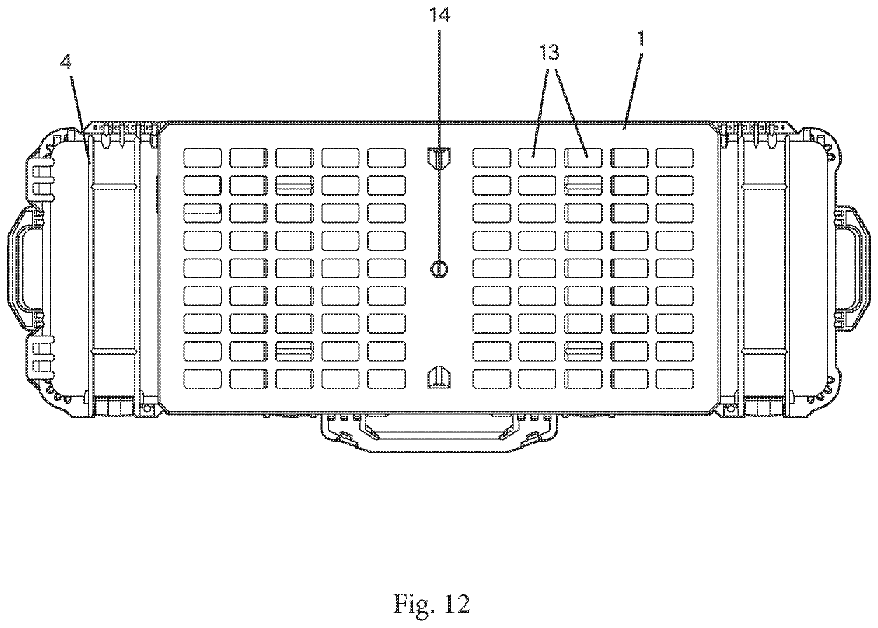

FIG. 12 is a top view of the third embodiment of the cover.

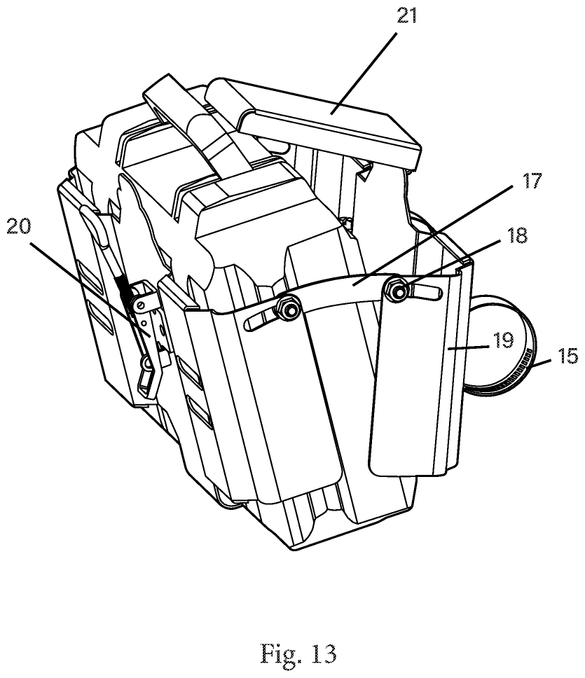

FIG. 13 is a perspective view of a fourth embodiment of the cover. Two cover halves 19 are hingeably attached to one another. The cover is made adjustable through abridger 17 that slides in and out, with the amount of movement temporarily restrained by adjustment bolts. A bridging hasp 21 removably mates with a latch clamp 20 to secure the front of the cover, and a radiator clamp 16 can be used to attach the device to any solid object.

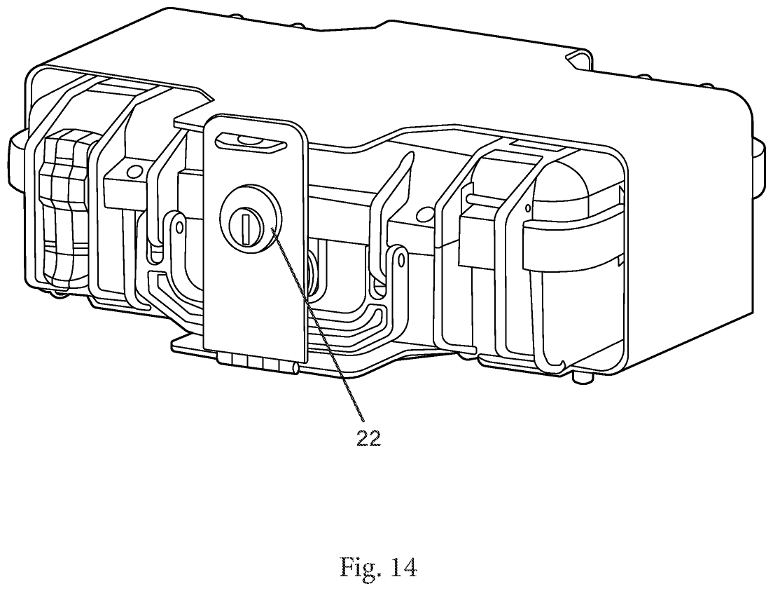

FIG. 14 is a front, perspective view of the invention with an integrated lock 22. The integrated lock can be incorporated into any of the preceding embodiments.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### REFERENCE NUMBERS USED

1. Cover
2. Hasp
3. Hinge
4. Case
5. Loop
6. Padlock
7. Bolt holes
8. Plate
9. Plate slots
10. Plate hole
11. Case handle
12. Stopper
13. Mesh openings
14. Securing screw
15. Uprights
16. Radiator clamp
17. Bridger
18. Adjustment bolts
19. Cover Halves
20. Latch Clamp
21. Bridging hasp
22. Integrated Lock

What I claim is:

1. A cover, wherein the cover has a top, a bottom, two sides, a back and a front, wherein the top, the bottom, the two sides and the back are closed, and the front is open, thereby creating a cavity into which a case removably fits, and a closure, wherein the closure extends from the top to the bottom of the case, and removably secures the case into the cover.

2. The cover of claim 1, wherein the closure comprises a hasp, wherein the hasp is hingeably connect to the bottom at a hinge, and wherein the hasp has a hasp slot, wherein the hasp slot mates with a loop, wherein the loop is located on the top, such that when the hasp slot is rotated through the loop, a padlock is placed on the loop to secure the case in the cover.

3. The cover of claim 2, wherein the bottom comprises one or more bolt holes, wherein one or more bolts can be inserted through the one or more bolt holes to secure the cover to a larger object, wherein the large object has one or more bolt receivers, and there the one or more bolts mate with the one or more bolt receivers.

4. The cover of claim 1, wherein the closure comprises a plate, wherein the plate has a stopper at a lower plate end and a plate hole at an upper plate end, wherein the
top of the cover and the bottom of the cover both have a plate slot, wherein the plate slot has a plate slot width, and wherein the plate has a plate width, and wherein the stopper has a stopper width, and there the stopper width is greater than the plate slot width, and wherein the place slot width is greater than the plate width, such that the plate is inserted through a bottom plate slot and then through a top plate slot, with the stopper preventing further insertion of the plate, and wherein the plate hole extends beyond the upper plate slot, and were a padlock is placed on the plate hole to secure the case in the cover.

5. The cover of claim 4, wherein the bottom comprises one or more bolt holes, wherein one or more bolts can be inserted through the one or more bolt holes to secure the cover to a larger object, wherein the large object has one or more bolt receivers, and there the one or more bolts mate with the one or more bolt receivers.

6. The cover of claim 5, wherein the plate extends on the inside of a case handle.

7. A cover, wherein the cover has a top, a bottom, a back and a front, wherein the top, the bottom, and the back are closed, and the front is open, thereby creating a cavity into which a case removably fits, and a closure, wherein the closure extends from the top to the bottom of the case, and removably secures the case into the cover.

8. The cover of claim 7, wherein the top and the bottom have a plurality of mesh holes.

9. The cover of claim 8, wherein the closure comprises three uprights, wherein one of the three uprights extends on the inside of a case handle.

10. A cover, wherein the cover has a top, a bottom, wherein the top and the bottom are closed, and the front is open, thereby creating a cavity into which a case removably fits, and a closure, wherein the closure extends from the top to the bottom of the case, and removably secures the case into the cover.

11. The cover of claim 10, wherein the top and the bottom have a distance between them, and the distance is adjustable through abridger, wherein the bridger can be removably secured in place by two adjustment bolts.

12. The cover of claim 11, wherein the closure comprises a bridging hasp and latch clamp, wherein the bridging hasp is connected to the top of the cover, and the latch clamp is attached to the bottom of the cover.

13. The cover of claim 12, additionally comprising a radiator clamp, wherein the radiator clamp creates an opening, wherein the opening has a variable diameter, wherein the variable diameter can be adjusted by tightening and untightening the radiator clamp, wherein the open is securable of a large object.

14. The cover of claim 13, wherein the large object is the bed of a pickup truck.

15. A cover, wherein the cover has a top, a bottom, wherein the top and the bottom are closed, and the front is open, thereby creating a cavity into which a case removably fits, and a closure, wherein the closure extends from the top to the bottom of the case, and removably secures the case into the cover, wherein an integrated lock is integrated into the closure.

16. The cover of claim 15, wherein the top and the bottom have a distance between them, and the distance is adjustable through abridger, wherein the bridger can be removably secured in place by two adjustment bolts.

17. The cover of claim 16, wherein the closure comprises a bridging hasp and latch clamp, wherein the bridging hasp is connected to the top of the cover, and the latch clamp is attached to the bottom of the cover.

18. The cover of claim 17, additionally comprising a radiator clamp, wherein the radiator clamp creates an opening, wherein the opening has a variable diameter, wherein the variable diameter can be adjusted by tightening and untightening the radiator clamp, wherein the open is securable of a large object.

19. The cover of claim 18, wherein the bottom comprises one or more bolt holes, wherein one or more bolts can be inserted through the one or more bolt holes to secure the cover to a larger object, wherein the large object has one or more bolt receivers, and there the one or more bolts mate with the one or more bolt receivers, wherein the closure comprises a plate, wherein the plate has a stopper at a lower plate end and a plate hole at an upper plate end, wherein the top of the cover and the bottom of the cover both have a plate slot, wherein the plate slot has a plate slot width, and wherein the plate has a plate width, and wherein the stopper has a stopper width, and there the stopper width is greater than the plate slot width, and wherein the place slot width is greater than the plate width, such that the plate is inserted through a bottom plate slot and then through a top plate slot, with the stopper preventing further insertion of the plate, and wherein the plate hole extends beyond the upper plate slot, and were a padlock is placed on the plate hole to secure the case in the cover.

20. The cover of claim 19, wherein the bottom comprises one or more bolt holes, wherein one or more bolts can be inserted through the one or more bolt holes to secure the cover to a larger object, wherein the large object has one or more bolt receivers, and there the one or more bolts mate with the one or more bolt receivers, wherein the plate extends on the inside of a case handle.
